(19) United States
(12) Patent Application Publication
(10) Pub. No.: US 2016/0229100 A1
(43) Pub. Date: Aug. 11, 2016

(54) COOLING APPARATUS - USING 3D PRINTED MICRO POROUS MATERIAL

(71) Applicants: Timothy Francis O'BRIEN, White Lake, MI (US); Daniel Vern BECKLEY, Byron, MI (US); Steven Douglas MCCLINTOCK, South Lyon, MI (US); MAGNA INTERNATIONAL INC., Aurora (CA)

(72) Inventors: Timothy F. O'Brien, White Lake, MI (US); Daniel V. Beckley, Byron, MI (US); Steven D. McClintock, South Lyon, MI (US)

(73) Assignee: MAGNA INTERNATIONAL INC., Aurora, ON (CA)

(21) Appl. No.: 15/027,139

(22) PCT Filed: Oct. 3, 2014
(86) PCT No.: PCT/US2014/059070

§ 371 Date: Apr. 4, 2016

Related U.S. Application Data
(60) Provisional application No. 61/886,938, filed on Oct. 4, 2013.

(51) Int. Cl. B29C 45/72; B22F 3/11; B29C 45/42

(52) U.S. Cl. CPC B29C 45/7207; B29C 45/42; B22F 3/1115; B33Y 80/00

(57) ABSTRACT

Cooling apparatus having a cooling box with integrated cooling and attachment features providing end of arm tooling to demold and cool molded parts. There is provided a net fit between a porous tool nest portion of the cooling box and the molded part being manufactured to allow the cooling cycle time to be reduced as the molded part finishes the cooling cycle in the end of arm tooling while a mold is closed and starts making the next molded part. The cooling box is connected to at least one vacuum line having a vacuum unit to generate a vacuum allowing for part demolding and cooling. The fully assembled form fitting cooling box is 3D printable to effectively create a partially solid and partially microporous cooling box.

### CROSS-REFERENCE TO RELATED APPLICATIONS

This application is a PCT International Patent Application and claims benefit of U.S. Provisional Patent Application No. 61/886,938 filed Oct. 4, 2013. The disclosure of the above application is incorporated herein by reference.

### FIELD OF THE INVENTION

The present invention relates to a cooling assembly and method for manufacturing same.

### BACKGROUND OF THE INVENTION

Standard injection molding arrangements and processes require long cycle times and have additional costs associated with secondary machinery and/or tooling. Generally, a part is molded within a cavity mold and then demolded. In one known attempt to improve prior standard methods the end of arm tooling is modified by using porous aluminum in order to try to demold injection molded parts more quickly. However, this attempt has been disadvantageous. Manufacturing of such a cooling tool for demolding is time consuming and extremely expensive.

Accordingly, a cooling assembly and method for making same is desired, which has integrated structural cooling features that reduce cycle time and also reduces tooling costs while increasing the speed of manufacturing of such cooling tooling.

### SUMMARY OF THE INVENTION

The present invention is directed to a cooling apparatus and a process operable for making same. There is provided a cooling apparatus having a cooling box mounted directly to a demolding robot. The cooling box has integrated cooling and attachment features. There is provided a net fit between the cooling box, and the cavity inside of the molded part being manufactured, to allow the cooling cycle time to be reduced as the molded part finishes the cooling cycle in the end of arm tooling while the mold is closed and starts making the next molded part. At least one portion of the cooling box includes a three dimensional (3D) printed portion that is partly solid and partly micro porous. A vacuum is pulled through the walls of the cooling box allowing for part demolding and/or fixturing while cooling.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross sectional view of a cooling apparatus coupled to an exemplary demolding robot arm, in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

There is provided an end of arm cooling fixture that is microporous and allows for reduced injection molding cycle time, e.g., at least 20% reduction in cycle time, low cost tooling, and which is a three-dimensional (3D) printable part nest that is at least 60% porous stainless steel.

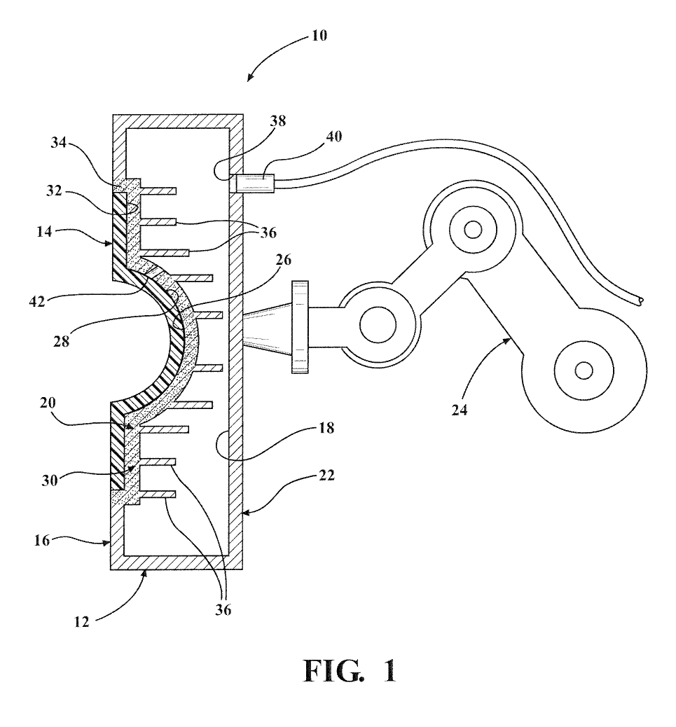

Referring generally to FIG. 1, there is provided a cooling apparatus, generally shown at 10, having a cooling box, generally shown at 12, that is operably configured for cooling and demolding a molded part, generally shown at 14. The cooling box 12 is operably configured to be partially porous for improving demolding and cycle time. The cooling box 12 forms a housing, generally shown at 16, with an internal chamber 18 or cavity. The housing 16 is partially solid and partially microporous. Preferably, the housing 16 is formed of a solid material except for at least one tool nest portion, generally shown at 20, which is microporous. Most preferably, the cooling box 12, e.g., housing portion 16, is 60% solid and 40% microporous. The internal chamber 18 is fully enclosed by the housing 16 which has no gaps or openings except for a port provided for a vacuum line and, optionally, at least one extra vacuum port, as will be explained in greater detail below.

The solid portion, generally shown at 22, of the housing 16 is integrally formed with the tool nest portion 20, and is operably mounted directly to a demolding robot, generally shown at 24, e.g., attachable to the robot using integrated robot attachment features such as threaded screw bosses, mounting plates, support ribs. The demolding robot 24 is connected to the rear of the housing 16 opposite the front where the tool nest 20 is located. Alternatively, the demolding robot 24 is connectable to the top or bottom of the cooling apparatus 10 depending on particular applications and working cell parameters.

The tool nest portion 20 has an integrally formed at least one curved surface portion 26 and at least one flange portion 30 operably configured to net fit to the molded part 14 to be demolded. At least one lip 34 extends from the flange portion 30 to contact the outer edge of the molded part 14 and is disposed between this outer edge and the solid portion 22 of the housing 16. In a preferred embodiment, the curved surface 26 of the tool nest portion 20 substantially forms a hemisphere-shape or semicircle-like cross-section protruding into the internal chamber 18 and forms an open area to laterally receive the molded part 14 therein. When loaded into the cooling box 12, the curve surface 26 generally follows the outer contour of the cavity section of the molded part 14. When the cooling apparatus 10 retrieves the molded part 14, a first outer surface 28 of the molded part 14 is selectively held in engagement with the curved surface 26 and a second outer surface 32 of the molded part 14 is selectively held in engagement with the flange portion 30. Other cross-sections of the cooling apparatus 10 and all features are contemplated such that any structural features described herein will be implementable on any other molded part application/dimensions and suitably adjusted to net fit to the molded part to be demolded.

The cooling box 12 also has a plurality of integrated internal cooling ribs or fins 36 integrally formed with and extending from the tool nest portion 20 into the internal chamber 18 to improve the cooling cycle time to a predetermined temperature. The ribs 36 are preferably solid and extend linearly from the rear of the tool nest portion 20 toward the back of the cooling box 12. The ribs 36 are spaced apart a predetermined operable amount and arranged parallel with one another. The ribs 36 also have various lengths.

At least one port 38 is operably provided in the housing 16 of the cooling box 12. A vacuum line 40 is operably coupled thereto and in fluid communication with the internal chamber 18 for providing a vacuum through the cooling box. Preferably, there is provided integration of vacuum line attachment features for connection to the vacuum line 40. The vacuum line 40 is coupled to a vacuum unit suitable to selectively remove a predetermined amount of air from the internal chamber 18 and create a predetermined pressure differential between the internal chamber 18 and atmosphere. A vacuum or vacuum force is generated operable to demold and cool the molded part 14 for a predetermined duration before the molded part 14 is released from the tool nest portion 20. The cooling cycle is reduced since the molded part 14 finishes the cooling cycle in the cooling apparatus 10 while the mold is closed and starts making the next part(s). Optionally, at least one additional vacuum port, generally shown at 42, is provided through the tool nest portion 20.

Further, in accordance with the present invention 3D printing techniques and machinery are operably configured and adjusted to 3D “print” the end of arm cooling box 12 that is to be net fit to the cavity side of the molded part 14 to be demolded. A fully assembled form fitting cooling box 12 is provided. The cooling box 12 is mounted directly to the demolding robot 24 and is a net fit to the cavity inside of the molded part 14. This allows the cooling cycle to be cut, e.g., by at least half, since the molded part 14 finishes the cooling cycle in the end of arm tooling (cooling box 12) while the mold is closed and starts making the next part. The printed cooling box 12 is solid and microporous, preferably, 60% solid and 40% microporous. This allows for improved demolding and cooling cycle times. Additional vacuum ports 42 can be formed into the cooling box, e.g., through the microporous tool nest portion 18 when printing the cooling box 12, to additionally help aid in part demolding and fixturing while cooling a predetermined amount.

The embodiments of the present invention improve cycle time over standard injection molding processes, e.g., improvement in cycle time is at least 25%. The improved cycle time is made without substantial cost, which is a significant benefit over conventional systems/methods, and can help to eliminate secondary machinery or tooling. Using 3D printing allows for the manufacturing of an at least partially porous cooling box. The cost of “printing” and sintering such cooling tools is significantly lower. The speed of manufacturing cooling tools is significantly improved, e.g., builds cooling box 12 overnight. By way of non-limiting example, the build rate is at least ¼ inch per hour. Stainless steel powder, aluminum powder, magnesium powder and the like or other suitable materials can be used for the cooling box 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cooling apparatus for demolding and cooling molded parts, comprising:
a cooling box including a housing having a solid portion integrally formed with at least one tool nest portion that is microporous;
an internal chamber located within said housing;
a plurality of integrated internal cooling ribs located within said internal chamber; and
at least one vacuum line operably connected to said housing in fluid communication with said internal chamber operable to generate a vacuum for demolding said molded part from a mold cavity;
wherein said tool nest portion operably follows the contour of said molded part and cools said molded part for a predetermined duration to a predetermined temperature after demolding.

2. The cooling apparatus of claim 1, wherein the cooling box is 60% solid and 40% micro porous.

3. The cooling apparatus of claim 1, wherein the cooling box is a 3D printed fully assembled form fitting cooling box.

4. The cooling apparatus of claim 3, wherein the plurality of integrated internal cooling ribs are integrally formed with the tool nest portion and are not microporous.

5. The cooling apparatus of claim 1, wherein said tool nest portion is a net fit to a cavity side of the molded part operable to allow a cooling cycle to be reduced.

6. The cooling apparatus of claim 5, wherein the cooling cycle is reduced by at least 50% as the molded part finishes the cooling cycle in the cooling apparatus while the mold cavity is closed and starts making the next molded part.

7. The cooling apparatus of claim 1, wherein the vacuum line and cooling box are configured to selectively allow for a vacuum to be pulled through the walls of the tool nest portion, allowing for the molded part demolding.

8. The cooling apparatus of claim 7, wherein said solid portion of the housing includes integration of vacuum line attachment features operable to provide at least one port through the housing and connection to the at least one vacuum line.

9. The cooling apparatus of claim 1, further comprising at least one additional vacuum port extending though said tool nest portion.

10. The cooling apparatus of claim 1, wherein the cooling box is 3D printed out of material selected from the group consisting of stainless steel powder, aluminum powder, and magnesium.

11. The cooling apparatus of claim 1, wherein the plurality of integrated internal cooling ribs are integrally formed with the tool nest portion and are not microporous.

12. The cooling apparatus of claim 1, wherein the cooling box is operably mounted directly to a demolding robot arm.

13. A method for making a cooling apparatus for cooling and demolding an injection molded part, comprising:
printing with a 3D printing device a cooling box that is a fully assembled form fitting cooling box;
wherein said cooling box comprises:
a housing having a solid portion integrally formed with at least one tool nest portion that is microporous;
an internal chamber located within said housing;
a plurality of integrated internal cooling ribs located within said internal chamber, wherein the plurality of integrated internal cooling ribs are integrally formed with the tool nest portion and are not microporous;
an integrated vacuum line attachment fitting including at least one port and operably connected to a vacuum line in fluid communication with said internal chamber operable to generate a vacuum pulled through the cooling box for demolding said molded part from a mold cavity;
integrated robotic attachment features for operably mounting said cooling box directly to a demolding robot; and
optionally, at least one additional vacuum port extending though said tool nest portion;
wherein said tool nest portion operably follows the contour of said molded part and cools said molded part for a predetermined duration to a predetermined temperature after demolding.

14. The method for making a cooling apparatus of claim 13, further comprising operably configuring a printing device to 3D print said cooling box.

15. The method for making a cooling apparatus of claim 13, wherein said cooling box is a 3D printed fully assembled form fitting cooling box operably configured to mount directly to the demolding robot and to be a net fit to a cavity side of the molded part.

16. The method for making a cooling apparatus of claim 13, wherein the cooling box is 60% solid and 40% micro porous.

17. The method for making a cooling apparatus of claim 13, wherein a cooling cycle is reduced by at least 50% as the molded part finishes the cooling cycle in the cooling apparatus while the mold cavity is closed and starts making the next molded part.

18. The method of claim 13, wherein at least the tool nest portion is printed of material selected from the group consisting of stainless steel powder, aluminum powder, and magnesium.

19. The method of claim 13, wherein a build rate for making the cooling box is about ¼ inch per hour.

20. A cooling apparatus for demolding and cooling an injection molded part, comprising:
a cooling box including a housing having a solid portion integrally formed with at least one tool nest portion that is microporous;
an internal chamber located within said housing;
a plurality of integrated internal cooling ribs located within said internal chamber, wherein the plurality of integrated internal cooling ribs are integrally formed with the tool nest portion and are not microporous;
at least one vacuum line operably connected to said housing in fluid communication with said internal chamber operable to generate a vacuum for demolding said molded part from a mold cavity; and
optionally, at least one additional vacuum port located through the tool nest portion to further assist in molded part demolding and fixturing while cooling a predetermined amount;
wherein said tool nest portion operably follows the contour of said molded part and cools said molded part for a predetermined duration to a predetermined temperature after demolding;
and further wherein the cooling box is a 3D printed fully assembled form fitting cooling box mountable directly to a demolding robot arm.
